(19) United States
(12) Patent Application Publication
(10) Pub. No.: US 2013/0054211 A1
(43) Pub. Date: Feb. 28, 2013

(54) UNIT COMMITMENT FOR WIND POWER GENERATION

(71) Applicants: Carsten FRANKE, Stetten (CH); Giovanni BECCUTI, Zurich (CH)

(72) Inventors: Carsten FRANKE, Stetten (CH); Giovanni BECCUTI, Zurich (CH)

(73) Assignee: ABB RESEARCH LTD, Zurich (CH)

(21) Appl. No.: 13/595,469

(22) Filed: Aug. 27, 2012

(30) Foreign Application Priority Data
Aug. 26, 2011 (EP) 11179010.1

(51) Int. Cl. G06G 7/48

(52) U.S. Cl. 703/6

(57) ABSTRACT

A method is disclosed for performing stochastic unit commitment for an electric power grid with a first weather dependent power generation unit and a second weather dependent power generation unit and a number of loads. For each of the first and the second power generation units, a plurality of scenarios indicative of future power production is based on weather forecast data: First and second correlated scenarios are identified for the first and second weather dependent power generation units, respectively. The stochastic unit commitment is based on a single combined scenario representing the first and the second scenarios of the pair of correlated scenarios.

### RELATED APPLICATION(S)

This application claims priority under 35 U.S.C. §119 to European Patent Application No. 11179010.1 filed in Europe on Aug. 26, 2011, the entire content of which is hereby incorporated by reference in its entirety.

### FIELD

The disclosure relates to the control of electric power grids, a method for performing stochastic unit commitment for an electric power grid, to an energy management system, and to a computer program and to a computer readable medium.

### BACKGROUND INFORMATION

Unit commitment can be seen as finding an optimal operation state of power generation units connected to an electric power grid for a certain load request on the electric power grid. The optimal operation state can include decisions as to which power generation units should be on or off and the production level of the operating power generation units. The operation state of the power generation units can be directed to optimizing with respect to costs, CO2 production and the transmission capabilities of the electric power grid.

A known approach for unit commitment focuses on determining the optimal settings and power dispatching of thermoelectrical plants given a certain load request. This amounts to solving a mixed integer nonlinear optimization problem, where the decision variables represent the unit settings and power production level, the constraints model the power demand, generation limitations (for example, ramp up/shut down phase, minimum/maximum production constraints) and network limits. The objective function can capture the associated production costs. The resulting optimization is completely deterministic. Full knowledge is assumed concerning system data.

More recent work has dealt with the introduction of renewable energy generation such as wind power generation units. In principle, the concept is the same. However, the main distinction is that the availability of wind power production is unknown to the extent that one must rely on the available wind forecast, which inherently features some degree of uncertainty which can be described by uncertainty intervals around a predicted mean value. The resulting optimization problem is thus stochastic because power production is tied to probabilities.

In order to make informed decisions in the presence of uncertainties, risk management problems of power utilities can be modeled by multistage stochastic programs. These programs can generate (through sampling) a set of scenarios/plausible realizations and corresponding probabilities to model the multivariate random data process (for example, for the considered case the generation capability of wind power generation units). The number of scenarios needed to accurately represent the uncertainty involved can be large.

Furthermore an individual set of scenarios is generated for each wind power generation unit. These predicted scenarios then need to be combined in many different ways in order to address the stochastic nature of the problem. If one considers that realistic unit commitment problems can feature tens or hundreds of units this can lead to an exponentially complex scenario tree over which the optimization has to be performed. Because of the unavoidable computational and time limitations, scenario reduction techniques must then be utilized. Here, the goal is to reduce the number of scenarios that must be evaluated in order to fit the computational time restrictions for solving the unit commitment problem. On the other hand the resulting unit commitment problem should capture the probabilistic aspects of physical reality sufficiently well. Otherwise the execution of the unit commitment itself would be meaningless.

Techniques for reducing the number of scenarios have been applied for a variety of power management problems and also for wind power production, considering the intermittency of individual wind farms. These scenario reduction methods use different probability metrics to select the desired set of scenarios. The scenario to be deleted is selected by comparing each scenario with the rest of the scenarios. Specifically, scenario reduction techniques can eliminate scenarios with very low probability and aggregate close scenarios by measuring the distance between scenarios based on probability metrics.

### SUMMARY

A method is disclosed of performing stochastic unit commitment for an electric power grid including a first weather dependent power generation unit, a second weather dependent power generation unit, and a number of loads, the method comprising providing weather forecast data for the first and second weather dependent power generation units, generating, for each of the first and the second power weather dependent generation units, a plurality of scenarios indicative of future power production based on the weather forecast data, identifying, according to a correlation criterion, a pair of correlated scenarios having a first scenario for the first weather dependent power generation unit and a second scenario for the second weather dependent power generation unit, and performing the stochastic unit commitment based on a single combined scenario representing the first scenario and the second scenario of the pair of correlated scenarios.

A non-transitory computer-readable medium is disclosed for storing computer program instructions which when executed by a computer programmed with the instructions causes the computer to perform stochastic unit commitment for an electric power grid including a first weather dependent power generation unit, a second weather dependent power generation unit, and a number of loads, the method for performing stochastic unit commitment comprising: providing weather forecast data for the first and second weather dependent power generation units, generating, for each of the first and the second weather dependent power generation units, a plurality of scenarios indicative of future power production based on the weather forecast data, identifying, according to a correlation criterion, a pair of correlated scenarios having a first scenario for the first weather dependent power generation unit and a second scenario for the second weather dependent power generation unit and performing the stochastic unit commitment based on a single combined scenario representing the first scenario and the second scenario of the pair of correlated scenarios.

An energy management system is disclosed for forecasting, monitoring and/or controlling the power production of power generation units of an electric power grid, comprising first and second weather dependent power generation units and a processor for performing stochastic unit commitment for an electric power grid including the first weather dependent power generation unit, the second weather dependent power generation unit, and a number of loads, stochastic unit commitment processor including means for providing weather forecast data for the first and second weather dependent power generation units, generating, for each of the first and the second power generation units, a plurality of scenarios indicative of future power production based on the weather forecast data, identifying, according to a correlation criterion, a pair of correlated scenarios having a first scenario for the first weather dependent power generation unit and a second scenario for the second weather dependent power generation unit and performing the stochastic unit commitment based on a single combined scenario representing the first scenario and the second scenario of the pair of correlated scenarios.

### BRIEF DESCRIPTION OF THE DRAWINGS

The subject matter of the disclosure will be explained in more detail in the following text with reference to exemplary embodiments which are illustrated in the attached drawings.

FIG. 1 schematically shows an electric power grid according to an exemplary embodiment of the disclosure;

FIG. 2 shows a flow diagram for a method for performing stochastic unit commitment according to an exemplary embodiment of the disclosure;

FIG. 3 shows a diagram with a scenario tree according to an exemplary embodiment of the disclosure;

FIG. 4 shows a diagram with two scenario trees according to an exemplary embodiment of the disclosure; and

FIG. 5 shows a diagram with two scenario trees according to an exemplary embodiment of the disclosure.

In principle, identical parts are provided with the same reference symbols in the figures.

### DETAILED DESCRIPTION

Exemplary embodiments of the disclosure relate to reducing the computing time of unit commitment for an electric power grid including, for example, wind power generation units.

A first exemplary embodiment of the disclosure relates to a method for performing stochastic unit commitment for an electric power grid with a first weather dependent power generation unit and a second weather dependent power generation unit and a number of loads.

According to an exemplary embodiment of the disclosure, the method includes providing weather forecast data for the first and second power generation units, (b) generating, for each of the first and the second power generation units, a plurality of scenarios indicative of future power production based on the weather forecast data, (c) identifying, according to a correlation (or similarity) criterion, a pair of correlated scenarios (26a, 26b) including a first scenario (26a) for the first weather dependent power generation unit (14b) and a second scenario (26b) for the second weather dependent power generation unit (14c), and (d) performing the stochastic unit commitment based on a single combined scenario representing the first and the second scenario of the pair of correlated scenarios (26a, 26b).

Rather than relying on the somewhat abstract procedure of generating scenarios through simulations and employing probability metrics to eliminate unlikely or redundant scenarios, the proposed embodiment exploits the fact that weather forecasts are not geographically independent but rather inherently interrelated in this respect, as physically intuitive.

For example, in case of co-located wind power generation units or wind farms (for example, wind farms which are physically close), a set of plausible future wind scenarios is determined for one wind power generation unit and then a similar or at least related set of scenarios can be simultaneously derived for the other co-located wind power generation units, depending on their proximity to the first unit and on the related wind forecast.

Thus, the number of scenarios need not explode exponentially (or at least need not increase nearly as quickly) when one takes into account all weather dependent power generation units, because a large number of physically inconsistent scenarios can be inherently excluded from being enumerated. Consequently, the optimization method can be more efficiently performed over this intrinsically reduced number of scenarios, which can be furthermore built by definition to match the physical forecast.

An exemplary embodiment of the disclosure relates to an energy management system for forecasting, monitoring and/or controlling the power production of power generation units of an electric power grid. For example, the energy management system can forecast and/or control the power production of convectional power production units and weather dependent power generation units.

According to an exemplary embodiment of the disclosure, the energy management system includes weather dependent power generation units and can be adapted to perform the method as described above and in the following. It is understood that features of the method as described above and in the following can be features of the system as described in the above and in the following.

An exemplary embodiment of the disclosure relates to at least one processor and a computer program for performing stochastic unit commitment for an electric power grid, which, when being executed by the at least one processor, is adapted to carry out the steps of the method as described in the above and in the following. For example, the computer program may be run on equipment of the energy management system. The at least one processor (for example, general purpose or application specific) of a computer processing device can be configured to execute a computer program tangibly recorded on a non-transitory computer-readable recording medium, such as a hard disk drive, flash memory, optical memory or any other type of non-volatile memory. Upon executing the program, the at least one processor is configured to perform the operative functions of the exemplary embodiments

These and other aspects of the disclosure will be apparent from and elucidated with reference to the embodiments described hereinafter.

An exemplary embodiment of the disclosure relates to a computer-readable medium, in which such a computer program is stored. A computer-readable medium may be a floppy disk, a hard disk, an USB (Universal Serial Bus) storage device, a RAM (Random Access Memory), a ROM (Read Only memory) and an EPROM (Erasable Programmable Read Only Memory). A computer readable medium may also be a data communication network, e.g. the Internet, which allows downloading a program code.

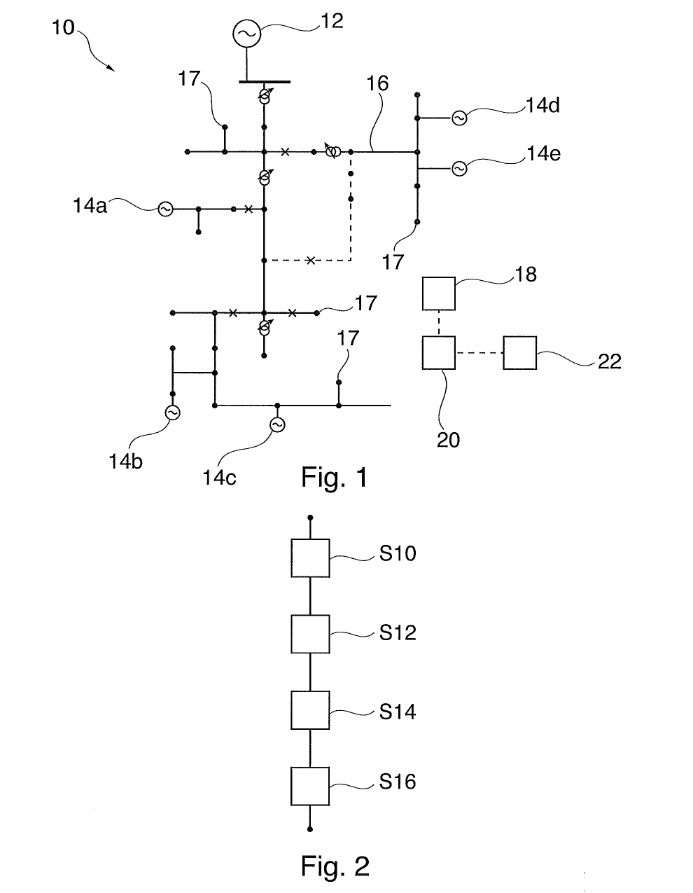

FIG. 1 shows a simplified electric power grid 10 with a thermoelectric plant 12 and weather dependent power generation units 14a, 14b, 14c, 14d, 14e which can be wind power generation units, for example wind farms, or solar power generation units. The power generation units 12, 14a, 14b, 14c, 14d, 14e are interconnected via transmission lines 16 with electric loads 17.

According to an exemplary embodiment of the disclosure, the electric power grid 10 can include a non-weather dependent power production unit 12.

The weather dependent power generation unit 14a is not co-located with any other weather dependent power generation unit. For example, the distance to other weather dependent power generation units can be more than 100 km. The weather dependent power generation units 14b and 14c are co-located similarly to wind farms 14d and 14e. For example, the weather dependent power generation units 14b, 14c (and the weather dependent power generation units 14d, 14e) are closer than 10 km.

A SCADA system 18 monitors the electric power grid 10 and provides data of the electric power grid, in particular the states of the transmission lines 16 and the power generation units 12, 14a, 14b, 14c, 14d, 14e, to an energy management system 20.

The energy management system 20 is also connected to a weather forecast provider 22. Based on the data from the SCADA system 18 and the weather forecast provider 22 the energy management system 20 performs a forecast for unit commitment as described with respect to FIG. 2.

The energy management system 20 can perform many applications focusing on different aspects of the operation of the electric power grid 10. For example, one of these applications can be the contingency analysis that analyzes the impact of potential variations of system components to the overall system operation. The contingency analysis uses the actual system state and parameter forecasts as inputs, and analyzes a predefined set of possible contingencies. The outcome of this real-time analysis can be the set of the most critical contingencies that could cause instabilities or overloads in the electric power grid 10. In the case of wind power generation, the contingency analysis application may need to address variations in wind and the corresponding wind power variations must be addressed. Additionally, geographical information and correlations between the behaviors of closely located wind power plants have to be integrated into the contingency analysis application. The same applies, when solar power generation units, which power generation depends on the cloudiness, are connected to the electric power grid 10.

FIG. 2 shows an exemplary method according to the disclosure for performing stochastic unit commitment.

In step S10 weather forecast data for a geographic area, in which the power generation units 14a, 14b, 14c, 14d, 14e are located, is provided by the weather forecast provider 22 and retrieved in the energy management system 10. The weather forecast data can include, for example, local wind data (with the strength and the direction of the wind) and/or cloudiness data.

In step S12, a plurality (or an exhaustive set) of scenarios indicative of future power production can be generated for the power generation units 14a, 14b, 14c, 14d, 14e in the energy management system 20 based on the weather forecast data.

According to an exemplary embodiment of the disclosure, at least one weather dependent power generation unit 14a, 14b, 14c, 14d, 14e can be a wind power generation unit (a wind farm) and the weather forecast data can include local wind forecast data. From this data the probabilistic behavior of the wind farm can be determined from the probabilities of different wind strengths.

According to an exemplary embodiment of the disclosure, at least one weather dependent power generation unit 14a, 14b, 14c, 14d, 14e can be a solar power generation unit and the forecast data can include cloudiness forecast data. For example, a solar power generation unit can include solar cells which power output is directly connected to the actual solar radiation.

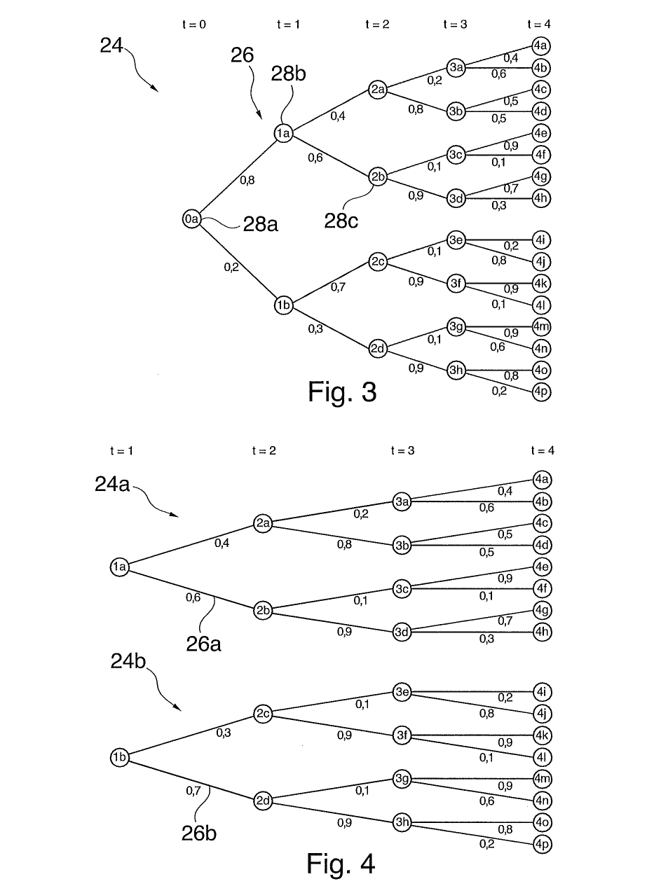

A scenario tree for a wind power generation unit 14a, 14b, 14c, 14d, 14e is described with respect to FIG. 3.

In step S14, the power management system 20 identifies pairs of similar scenarios according to a similarity criterion for meteorological related power generation units 14b, 14c (or 14d, 14e). Similarity criterions are described with respect to FIG. 4.

According to an exemplary embodiment of the disclosure, the method can include identifying, according to a correlation (similarity) criterion, a pair of correlated scenarios 26a, 26b including a first scenario 26a for the first weather dependent power generation unit 14b and a second scenario 26b for the second weather dependent power generation unit 14c.

In step S16, the power management system 20 performs a stochastic unit commitment for the identified pairs of similar scenarios. In this unit commitment process not only the weather dependent power generation units 14a, 14b, 14c, 14d, 14e are included but also the non-weather dependent power production units 12.

According to an exemplary embodiment of the disclosure, the method can include performing the stochastic unit commitment based on a single combined scenario representing the first and the second scenario of the pair of correlated scenarios 26a, 26b. The combined scenario can feature (identical) probabilities of the original scenarios with summed absolute power.

According to an exemplary embodiment of the disclosure, the stochastic unit commitment can include a unit commitment of a power production unit 12. The stochastic unit commitment can also be performed with (a deterministic scenario for) a non-weather dependent power generation unit.

Summarized, the method can require the weather forecast for a given geographical area to be available at a central location (for example the energy management system) 20 responsible for the optimal commitment and dispatching of a set of power generation units 12, 14a, 14b, 14c, 14d, 14e. The method can be executed on the standard hardware equipment already available at such centers 20.

FIG. 3 shows an exemplary scenario tree 24 representing the possible power generation of an individual power generation unit 14a, 14b, 14c, 14d, 14e, for example a wind or solar power generation unit. Starting at time 0, it is predicted that at time 1 either a certain (larger) amount of power could be produced (denoted by 1a) or another (lower) given power level (denoted by 1b). The same concept is used for all subsequent points in time t, so that one obtains a scenario tree 24 of increasing complexity, reflecting the different probabilistic combinations of weather behavior over time which results in different amounts of power being generated.

Different scenarios for one individual power generation unit can be derived from the scenario trio 24. In particular, a scenario 26 includes subsequent forecast steps 28a, 28b, 28c that model a power generation forecast. Each of the forecast steps 28a, 28b, 28c is defined by a forecasted power (or a power interval), a forecasted time (or time interval) and a probability. For example, the forecast step 28b can indicate that with a probability of 0.8 the power generation unit (for example 14a) can generate a power between, for example 8 to 9 MW, in the time between t=1 and t=2.

According to an exemplary embodiment of the disclosure, a scenario can include a number of subsequent forecast steps.

According to an exemplary embodiment of the disclosure, a forecast step can include a forecasted power, a forecasted time and/or a probability.

At the time when the example scenario tree 24 is generated, the possible power generation by the power generation unit 14a, 14b, 14c, 14d, 14e can only be predicted. Thus, moving from one point in time to the next, the likelihood of the new power generation should be re-evaluated. For example, the likelihood of change in power generation from one point in time to another reflects the presumably altered wind speed forecast and its associated uncertainty.

Later, when the power generation units 14a, 14b, 14c, 14d, 14e are operating, the real power generated can be evaluated. If the scenario trees 24 were appropriately and correctly formulated it can be likely that one of the predicted states for each point in time will be realized. For example, this can be the scenario 26. However, the sequence of steps 28a, 28b, 28c still has a probabilistic nature, so it need not match physical reality exactly.

Each of the power generation units 14a, 14b, 14c, 14d, 14e of FIG. 1 have their own power prediction scenario tree 24 as depicted in FIG. 3. However, the probabilities for moving from one power generation state to another might be different between the different power generation units 14a, 14b, 14c, 14d, 14e.

Without restricting to specific scenarios or to specific combinations of scenarios, the unit commitment problem should take into account all possible power generation transitions for all power generation units 14a, 14b, 14c, 14d, 14e and for each point in time t. Considering all possible combinations quickly can lead to a problem which can be computationally intractable. However, due to the restriction to pairs or combinations of scenarios that are meteorological interrelated, this problem may be overcome.

Furthermore, the number of scenarios for a single power generation unit can be reduced before or after the identification of correlated pair of scenarios of different power generation units 14a, 14b, 14c, 14d, 14e.

According to an exemplary embodiment of the disclosure, the method includes de-selecting (prior or after step S14) scenarios that are unlikely to occur, according to a probability criterion and disregarding the deselected scenarios for the stochastic unit commitment. The probability criterion can be a threshold for an accumulated scenario probability.

To generate the forecast tree 24, a forecast horizon of up to 24 hours can be of interest, generally in steps of 1h. Current forecasting tools can provide a relatively accurate assessment and forecast of the production of power from a weather dependent power generation unit 14a, 14b, 14c, 14d, 14e for such a forecast horizon.

For example, one such forecasting tool uses a two stage procedure where a numerical weather prediction service is first used to obtain wind forecasts. Models of wind turbines and wind farms, and information about their physical characteristics, are then combined with the wind forecasts and used to create corresponding power generation forecasts with associated confidence intervals and/or estimates of the statistical distribution of the production of a function of forecasted time. Exemplary forecast inaccuracies in percent of rated power are 3-5% for large groups of wind turbines and up to 10% for individual wind power turbines. The wind power forecast usually only provides the predicted power generation by the specified wind generation component in terms of the expected power output and the upper and lower confidence intervals, i.e. forecast per wind farm, not per individual unit within the farm.

FIG. 4 shows two scenario trees 24a, 24b for two meteorologically close weather dependent power generation units 14a, 14c. The main principle to reduce the number of combined scenarios 26a, 26b that need to be evaluated during the unit commitment is based on an evaluation of the cases in which the weather dependent power generation units 14a, 14b are meteorologically interrelated. For example, the power generation units 14a, 14b can be wind farms that are likely to observe similar wind conditions or are solar power generation units that receive nearly the same amount of solar radiation.

According to an exemplary embodiment of the disclosure, pairs of similar scenarios 26a, 26b are identified for meteorologically close weather dependent power generation units 14a, 14b.

One possibility of being meteorologically close is that the power generation units 14a, 14b are co-located. In other words, the power generation units 14a, 14b can be neighboring or may be closer than 10 km. In this case, the power generation units 14a, 14b can have locally correlated power production due to the local weather.

According to an exemplary embodiment of the disclosure, pairs of similar scenarios are identified for co-located weather dependent power generation units.

For example, if two power generation units 14b, 14c are co-located, the probability of having a similar “walk-through” for the related scenario trees 24a, 24b is very high. For example in the case of wind power generation, the wind farms 14b and 14c should reasonably observe similar wind conditions. Thus, assuming that wind farm 14b leads to the scenario 26a (1a-2b-3d-4h) then the walk-through of the scenario tree 24b for wind farm 14c will plausibly be similar to the scenario 26b (1b-2d-3h-4p). The same conclusions can be drawn for wind farms 14d and 14e, that is these latter power generation units 14d, 14e will behave in a similar fashion. On the basis of this it is possible to group together scenario trees 24a, 24b of co-located wind farms 14b, 14c and reduce the complexity of the overall unit commitment problem.

Note that in FIG. 3, the different probabilities can emanate from the fact that the two wind farms 14b, 14c rely on wind forecast from different providers 22.

In general, FIG. 3 shows scenario trees 24a, 24b of wind farms 14b, 14c with similar wind conditions in simplified form. Here, the two wind farms 14b, 14c are behaving identically over time. Of course, a real-life application will allow for small deviations.

Pairs of similar scenarios can be identified in the following way. For each two scenario trees 24a, 24b, a first scenario 26a can be picked from the first scenario tree 24a and a second scenario 26b can be picked from the second scenario tree 24b. The two scenarios 26a, 26b are then compared.

The two scenarios 26a, 26b can be similar (for example, for each of their forecasting steps), if the amount of relative forecasted power is comparable within 10-20%. The relative forecasted power can be a fraction of the maximum power of the respective power generation unit 14b, 14c.

According to an exemplary embodiment of the disclosure, the first scenario 26a and second scenario 26b can include a relative forecasted power. The first scenario 26a can be similar to the second scenario 26b, when the relative forecasted power of the first scenario 26a and the relative forecasted power of the second scenario 26b differ not more than 20%, for example, not more than 10%.

In particular, scenarios 26a, 26b with forecast steps may be similar, if for each of the forecasting steps, the forecasted power at the forecasted time is similar (e.g., differs not more than the above given values).

Similarity may also be measured in terms of wind and/or weather conditions, for example wind speed, luminosity. In most cases this can map to power forecast but the generation capabilities might not depend linearly on the weather conditions. A similarity can also be measured in terms of likelihood or probability of occurrence.

According to an exemplary embodiment of the disclosure, a scenario 26a, 26b can include a number of subsequent forecast steps 28a, 28b, 28c each having a forecasted power and probability, the method including identifying the first scenario 26a and the second scenario as a pair of correlated scenarios 26a, 26b if a first sequence of forecasted probabilities of the first scenario and a second sequence of probabilities of the second scenario are identical or within a predefined band (for example the probability of the second sequence is within +/−10% of the first sequence) at each point in time for which the unit commitment is executed.

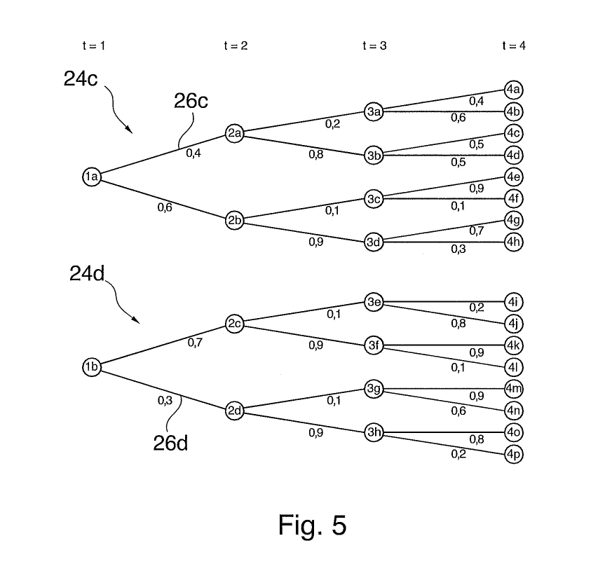

FIG. 5 shows scenario trees 24c, 24d for two wind farms (for example 14b and 14d) that do not observe similar wind conditions. The generated power levels and the respective scenarios 26c, 26d can be totally unrelated and decoupled as shown in FIG. 5.

Alternatively or additionally to the embodiment with co-located power generation units, 14b, 14c which uses the local correlation of weather conditions, an embodiment with timely correlated weather conditions can be used. In this case, the wind directions of the weather forecast can be used to interrelate scenarios that are time delayed with respect to each other.

Using the example from FIG. 1, it can be possible that the wind blows from the direction of wind farms 14d, 14e in the direction to a wind farm 14a. Furthermore, the wind farms 14d, 14e and 14a cannot be co-located but can also not be too far away from each other (for example less than 100 km). Then it may be assumed that a similar wind condition that was observed at the wind farms 14d, 14e will be observed at wind farm 14a after a certain time delay (which then depends on the wind strength and the wind direction). In other words, the power generation units 14d, 14e, 14e can have timely correlated power production due to the weather forecast. This can again decrease the number of overall system scenarios 26a, 26b that need to be evaluated.

According to an exemplary embodiment of the disclosure, the weather forecast data includes wind forecast data that can include local wind strength and local wind direction data. Pairs of similar scenarios can be identified for weather dependent power generation units that have correlated weather conditions based on the wind forecast data.

In this case, a first and second scenarios can be similar, if forecast steps of the first scenario that are time shifted by a specific wind dependent time delay are similar to forecasts steps of the second scenario.

According to an exemplary embodiment of the disclosure, the first and second sequences of forecasted probabilities of the first and second scenario are time-wise delayed (in accordance with a distance between the two power generation units and an inter-unit wind or cloud speed).

While the disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art and practicing the claimed disclosure, from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of performing stochastic unit commitment for an electric power grid including a first weather dependent power generation unit, a second weather dependent power generation unit, and a number of loads, the method comprising:
providing weather forecast data for the first and second weather dependent power generation units;
generating, for each of the first and the second weather dependent power generation units, a plurality of scenarios indicative of future power production based on the weather forecast data;
identifying, according to a correlation criterion, a pair of correlated scenarios having a first scenario for the first weather dependent power generation unit and a second scenario for the second weather dependent power generation unit; and
performing the stochastic unit commitment based on a single combined scenario representing the first scenario and the second scenario of the pair of correlated scenarios.

2. The method of claim 1, comprising:
de-selecting scenarios, that are unlikely to occur, according to a probability criterion; and
disregarding de-selected scenarios for the stochastic unit commitment.

3. The method of claim 1, wherein a scenario includes a number of subsequent forecast steps each having a forecasted power and probability, the method comprising:
identifying the first scenario and the second scenario as a pair of correlated scenarios if a first sequence of forecasted probabilities of the first scenario and a second sequence of probabilities of the second scenario are identical or within a predefined band at each point in time for which the unit commitment is executed.

4. The method of claim 3, wherein the first and second sequences are time-wise delayed.

5. The method of claim 1,
wherein the first scenario and the second scenario each include a relative forecasted power; and
wherein the first scenario is similar to the second scenario, when the relative forecasted power of the first scenario and the relative forecasted power of the second scenario differ not more than 20%.

6. The method of claim 1, wherein a weather dependent power generation unit is a wind power generation unit and wherein the weather forecast data comprises:
local wind forecast data.

7. The method of claim 1, wherein a weather dependent power generation unit is a solar power generation unit, and wherein the forecast data comprises:
cloudiness forecast data.

8. The method of claim 1, wherein the electric power grid comprises:
a non-weather dependent power production unit, and wherein the stochastic unit commitment comprises:
a unit commitment of the non-weather dependent power production unit.

9. A non-transitory computer-readable medium storing computer program instructions which when executed by a computer programmed with the instructions causes the computer to perform stochastic unit commitment for an electric power grid including a first weather dependent power generation unit, a second weather dependent power generation unit, and a number of loads, a method for performing the stochastic unit commitment comprising:
providing weather forecast data for the first and second weather dependent power generation units;
generating, for each of the first and the second weather dependent power generation units, a plurality of scenarios indicative of future power production based on the weather forecast data;
identifying, according to a correlation criterion, a pair of correlated scenarios having a first scenario for the first weather dependent power generation unit and a second scenario for the second weather dependent power generation unit; and
performing the stochastic unit commitment based on a single combined scenario representing the first scenario and the second scenario of the pair of correlated scenarios.

10. The computer readable medium of claim 9, the stochastic unit commitment comprising:
de-selecting scenarios, that are unlikely to occur, according to a probability criterion; and
disregarding de-selected scenarios for the stochastic unit commitment.

11. The compute readable medium of claim 9, wherein a scenario includes a number of subsequent forecast steps each having a forecasted power and probability, and the stochastic unit commitment comprises:
identifying the first scenario and the second scenario as a pair of correlated scenarios if a first sequence of forecasted probabilities of the first scenario and a second sequence of probabilities of the second scenario are identical or within a predefined band at each point in time for which the unit commitment is executed.

12. The computer readable medium of claim 9, wherein the first and second sequences are time-wise delayed.

13. The computer readable medium of claim 9,
wherein the first scenario and the second scenario each include a relative forecasted power: and wherein the first scenario is similar to the second scenario, when the relative forecasted power of the first scenario and the relative forecasted power of the second scenario differ not more than 20%.

14. The computer readable medium of claim 9, wherein a weather dependent power generation unit is a wind power generation unit, and wherein the weather forecast data comprises:
local wind forecast data.

15. The computer readable medium of claim 9, wherein a weather dependent power generation unit is a solar power generation unit, and wherein the forecast data comprises:
cloudiness forecast data.

16. The computer readable medium of claim 9, wherein the electric power grid comprises:
a non-weather dependent power production unit, and wherein the stochastic unit commitment comprises:
a unit commitment of the non-weather dependent power production unit.

17. An energy management system for forecasting, monitoring and/or controlling the power production of power generation units of an electric power grid, comprising:
first and second weather dependent power generation units; and
a processor for performing stochastic unit commitment for an electric power grid including the first weather dependent power generation unit, the second weather dependent power generation unit, and a number of loads, the stochastic unit commitment processor including means for:
providing weather forecast data for the first and second weather dependent power generation units;
generating, for each of the first and the second weather dependent power generation units, a plurality of scenarios indicative of future power production based on the weather forecast data;
identifying, according to a correlation criterion, a pair of correlated scenarios having a first scenario for the first weather dependent power generation unit and a second scenario for the second weather dependent power generation unit; and
performing the stochastic unit commitment based on a single combined scenario representing the first scenario and the second scenario of the pair of correlated scenarios.

18. The energy management system of claim 17, the stochastic unit commitment comprising:
de-selecting scenarios, that are unlikely to occur, according to a probability criterion; and
disregarding the de-selected scenarios for the stochastic unit commitment.

19. The energy management system of claim 17, wherein a scenario includes a number of subsequent forecast steps each having a forecasted power and probability, and the stochastic unit commitment comprises:
identifying the first scenario and the second scenario as a pair of correlated scenarios if a first sequence of forecasted probabilities of the first scenario and a second sequence of probabilities of the second scenario are identical or within a predefined band at each point in time for which the unit commitment is executed.

20. The energy management system of claim 17, wherein the first and second sequences are time-wise delayed.

21. The energy management system of claim 17,
wherein the first scenario and the second scenario each include a relative forecasted power; and
wherein the first scenario is similar to the second scenario, when the relative forecasted power of the first scenario and the relative forecasted power of the second scenario differ not more than 20%.

22. The energy management system of claim 17, wherein a weather dependent power generation unit is a wind power generation unit, and
wherein the weather forecast data comprises:
local wind forecast data.

23. The energy management system of claim 17, wherein a weather dependent power generation unit is a solar power generation unit, and wherein the forecast data comprises:
cloudiness forecast data.

24. The energy management system of claim 17, wherein the electric power grid comprises a non-weather dependent power production unit, and wherein the stochastic unit commitment comprises:
a unit commitment of the non-weather dependent power production unit.
